(19) United States
(12) Patent Application Publication
(10) Pub. No.: US 2004/0259505 A1
(43) Pub. Date: Dec. 23, 2004

(54) Switch circuit especially suitable for use in wireless LAN applications

(76) Inventor: Karthik Vasanth, Richardson, TX (US)

Correspondence Address: TEXAS INSTRUMENTS INCORPORATED, P O BOX 655474, M/S 3999, DALLAS, TX, 75265

(21) Appl. No.: 10/465,337

(22) Filed: Jun. 19, 2003

(51) Int. Cl. H04B 1/44; H04B 1/38

(52) U.S. Cl. 455/78; 455/73

(57) ABSTRACT

A switch circuit selectively connects either a transmitter or a receiver to an antenna. The switch circuit has a transmitting pathway connecting the transmitter to the antenna 300 and containing only non-semiconductor elements (such as a first quarter-wave transmission line 313), and a receiving pathway connecting the antenna to the receiver and containing only non-semiconductor elements (such as a second quarter-wave transmission line 303). The switch circuit also has a switching arrangement (314A/B/C/D, 304A/B/C/D) configured to isolate the transmitter from the antenna while enabling the receiving pathway from the antenna to the receiver, and to isolate the receiver from the antenna while enabling the transmitting pathway from the transmitter to the antenna. Preferably, the transmitting pathway and receiving pathway include only elements having a very low insertion loss. A wireless local area network (WLAN) includes the transmitter, receiver, antenna and switch circuit.

### BACKGROUND OF THE INVENTION

1. Field of the Invention

The invention generally relates to circuits in which a single antenna is used for both transmitting and receiving. More particularly, the invention relates to switch circuits that selectively connect the antenna to either a transmitter or a receiver, especially switch circuits with small insertion loss.

2. Related Art

FIG. 1 depicts a conventional circuit in which FETs 102, 103 are used to switch an antenna 100 between a receiver and a transmitter. The gates of FETs 102, 103 are driven through respective resistors R2 and R3 by control signals of opposite polarity. The opposite-polarity control signals are provided by series-connected inverting buffers 199, 198, a first one of which receives a transmit/receive control signal. The opposite polarities of the control signals from inverting buffers 199, 198 ensure that only one of the receiver and transmitter is connected to antenna 100 at a given instant.

FETs 101, 104 receive the opposite-polarity signals from inverting buffers 198, 199, respectively, through respective resistors R1, R4. The resistors R1-R4, typically 5-10 KΩ, present high impedance to RF signals and thus minimize losses in the logic circuits shown.

During operation, FETs 101, 104 short (disable) the input path from the transmitter, or the output path to the receiver, respectively. Accordingly, the disabled transmitter does not interfere with or damage the enabled receiver when the receiver is connected to antenna 100. Conversely, the disabled receiver does not interfere with the enabled transmitter when the transmitter is connected to antenna 100.

Undesirably, FETs 102, 103 introduce significant insertion loss. In one experiment conducted at 3 GHz, measured using CMOS (complementary metal oxide semiconductor) switches, more than 0.6 dB insertion loss was experienced when measured using only a silicon probe. Approximately 1.2 dB insertion loss was experienced when package loss was included. Significantly, a 2.0 dB insertion loss was experienced when both package loss and matching network loss (for 50 Ω impedance matching) were included. Moreover, if the transmission frequency were to increase, for example, approaching and exceeding about 6 GHz, insertion losses would be even larger.

FIG. 2 illustrates another conventional circuit used to switch antenna 200 between a receiver and a transmitter. The transmitter is connected between an inductor 201 that is driven by a first switching voltage V_{SW1}, and a diode 202 that is connected to the antenna 200. On the receiver side, a quarter-wave transmission line 203 connects the antenna to the receiver. A diode 204 having a parasitic capacitance 205 controlled by a second switching voltage V_{SW2} is also connected to the receiver. An inductor 206 is connected between the receiver and ground, and counteracts the capacitance 205. During operation, the first and second switching voltages V_{SW1} and V_{SW2} are in opposite phase to prevent the receiver and transmitter from being connected to the antenna at the same time.

Diode 202 has a significant insertion loss. Moreover, at the frequencies at which the circuit is designed to operate (2-3 GHz), a transmission line a quarter wavelength long requires substantial space to fabricate on integrated circuits.

FIGS. 1 and 2 illustrate the problems common among switch circuits that selectively connect an antenna to either a receiver or a transmitter.

One conventional implementation uses CMOS (FIG. 1) or GaAs PHEMT (gallium arsenide, pseudomorphic high electron mobility transistor) technology. Any advantages of using CMOS elements are counteracted by the fact that the transmission lines leading from the transmitter and to the receiver must be terminated. Another conventional implementation involving a PIN diode (FIG. 2) shares the insertion loss problem possessed by the CMOS implementation. Both switch implementations include series-connected semiconductor devices that contribute to insertion loss. Even if silicon transistors are used to increase performance, that performance increase is compromised by necessary series tuning elements.

Conventional implementations for WLAN (wireless local area network) products require separately constructed switch circuits, and are typically based on GaAs or PIN diode technology, increasing the cost and size of the WLAN products' module. There is a push to integrate such switch circuits using CMOS technology, but the insertion loss associated with CMOS switches is high because they must be matched to off-chip components.

Accordingly, there is a need in the art to provide a switching arrangement with minimal insertion loss, especially a switching arrangement suitable for use in circuits in which an antenna must be selectively connected to either a receiver or a transmitter at a given instant.

### SUMMARY

Accordingly, there is provided a switch circuit that selectively connects either a transmitter or a receiver to an antenna. The switch circuit has a transmitting pathway connecting the transmitter to the antenna and containing only non-semiconductor elements (such as, in one embodiment, a first quarter-wave transmission line), and a receiving pathway connecting the antenna to the receiver and containing only non-semiconductor elements (such as, in one embodiment, a second quarter-wave transmission line). The switch circuit also has a switching arrangement configured to isolate the transmitter from the antenna while enabling the receiving pathway from the antenna to the receiver, and to isolate the receiver from the antenna while enabling the transmitting pathway from the transmitter to the antenna. Preferably, the transmitting pathway and receiving pathway include only elements having a very low insertion loss. A wireless local area network (WLAN) circuit includes the transmitter, receiver, antenna and switch circuit.

### BRIEF DESCRIPTION OF THE DRAWINGS

A more complete appreciation of the described embodiments is better understood by reference to the following Detailed Description considered in connection with the accompanying drawings, in which like reference numerals refer to identical or corresponding parts throughout, and in which:

FIG. 1 illustrates a conventional circuit in which FETs 102, 103 are used to switch an antenna 100 between a receiver and a transmitter;

FIG. 2 illustrates another conventional circuit, in which a diode 202, and a combination of a quarter-wave transmission line 203, diode 204, and inductor 206, are used to switch antenna 200 between a receiver and a transmitter;

FIG. 3A illustrates a first embodiment of a switch circuit, in which an arrangement of quarter-wave transmission lines, transistors and inductors are used to switch antenna 300 between a receiver and a transmitter;

FIG. 3B illustrates a second embodiment of a switch circuit, in which an RF choke arrangement, including inductors 305B and 315B, is used with transmit/receive mode block 390 and transistors 304B, 314B;

FIG. 3C illustrates a third embodiment of a switch circuit, in which diodes 304C and 314C are used as switching elements instead of the transistors of FIGS. 3A and 3B, and in which an RF choke arrangement, including inductors 305C and 315C, is used;

FIG. 3D illustrates a fourth embodiment of a switch circuit, in which MOSFETs 304D and 314D are used as switching elements instead of the transistors of FIGS. 3A and 3B or the diodes of FIG. 3C; and

FIGS. 4A and 4B are equivalent circuit diagrams of the embodiments of FIGS. 3A, 3B, 3C, 3D in converse situations: FIG. 4A illustrates an equivalent circuit diagram in a transmit mode in which the receiver is isolated from the antenna, whereas FIG. 4B illustrates an equivalent circuit diagram in a receive mode in which the transmitter is isolated from the antenna.

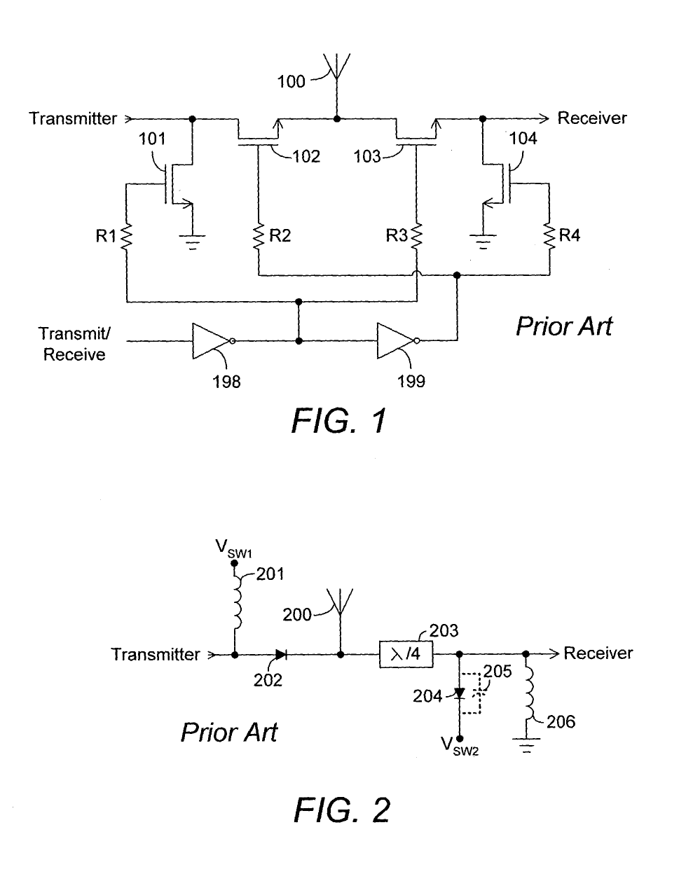

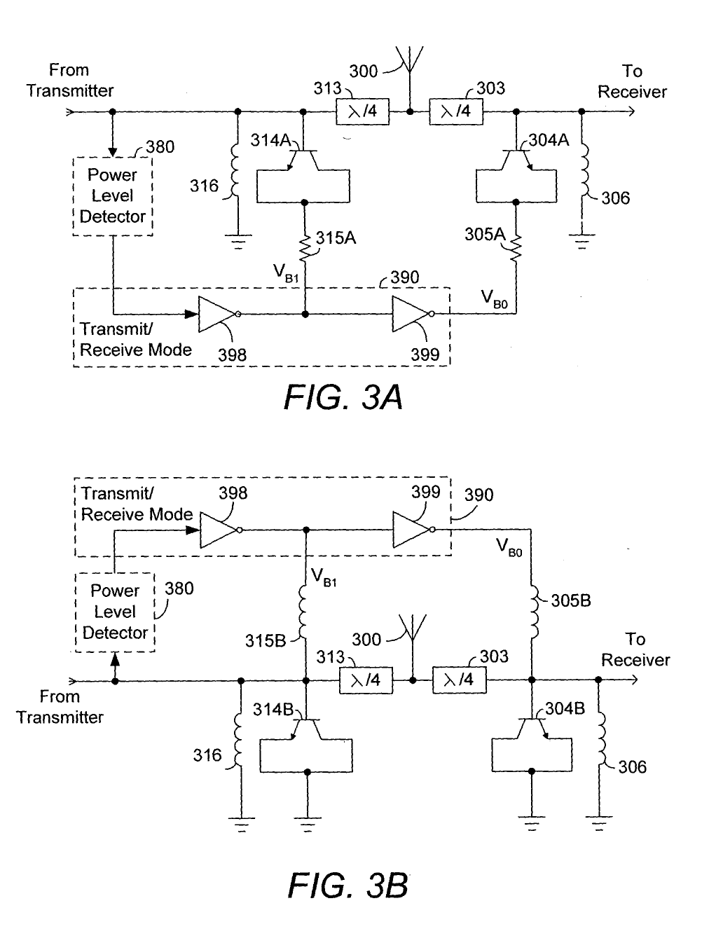

### DETAILED DESCRIPTION

In describing embodiments illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose. Various terms that are used in this specification are to be given their broadest reasonable interpretation when used in interpreting the claims.

Moreover, features and procedures whose implementations are well known to those skilled in the art are omitted for brevity. For example, design, selection, and implementation of basic electronic circuit elements such as signal level shifters, buffers, logic elements, current and voltage sources, diodes, bipolar transistors, metal oxide semiconductor field effect transistors (MOSFETs), transmission line delay elements, and the like, lies within the ability of those skilled in the art, and accordingly any detailed discussion thereof may be omitted.

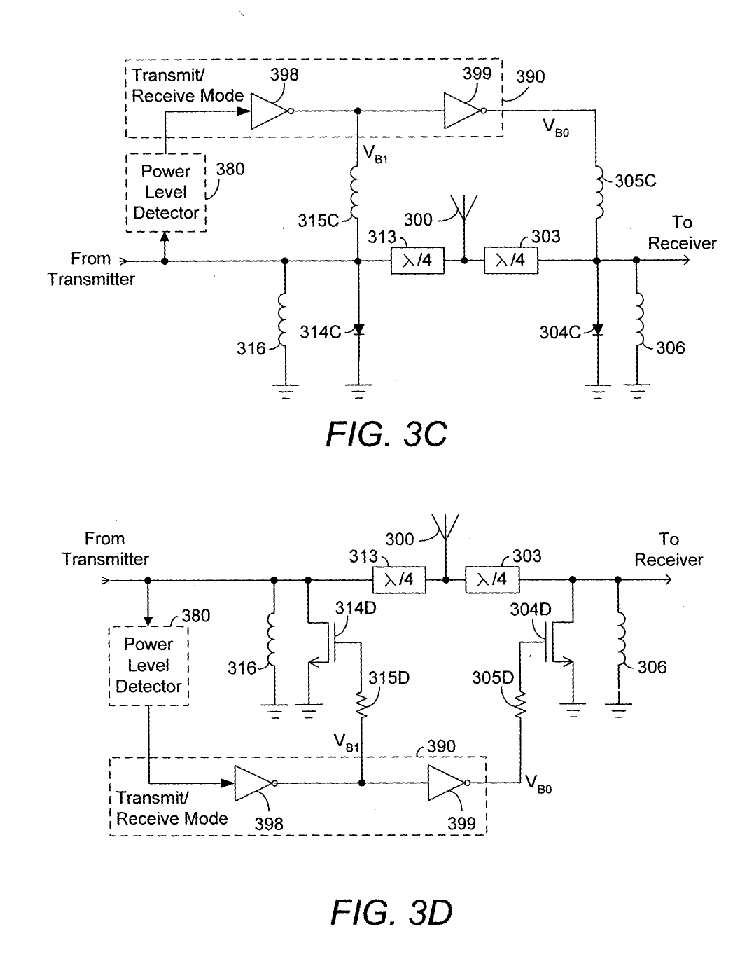

FIG. 3A illustrates an embodiment of a switch circuit in which an arrangement of quarter-wave transmission lines, transistors and inductors are used to switch an antenna between a receiver and a transmitter.

The receiver is connected to the antenna 300 by a pathway including a low insertion loss element, such as a non-semiconductor element, in this example a quarter-wave transmission line 303. The receiver is also connected to a suitable switching element. In the illustrated embodiment, the switching element is an npn transistor 304A whose base is connected to the receiver connection, and whose collector and emitter are connected in common to a control signal V_{B0}. An inductor 306 connects the receiver to ground.

On the transmitter side of the antenna in the FIG. 3A embodiment, circuitry is provided that may be symmetric about the antenna with the circuitry on the receiver side. The transmitter is connected to antenna 300 by a pathway including a low insertion loss element, such as a non-semiconductor element, in this example a quarter-wave transmission line 313. The transmitter is also connected to a suitable switching element. In the illustrated embodiment, the switching element is an npn transistor 314A whose base is connected to the transmitter connection, and whose collector and emitter are connected in common to a control signal V_{B1}. An inductor 316 connects the transmitter to ground.

A transmit/receive mode block (shown in dotted line block 390 to emphasize its optional nature) provides the control signals V_{B0} and V_{B1} to respective switching elements 304A, 314A through resistors 305, 315, respectively. During operation, each control signal V_{B0} and V_{B1} may take on a value of 0 volts or from 0.8-1.5 volts, depending on the technology type of switching elements such as bipolar transistors 304A, 314A. Transmit/receive mode block 390 determines control voltages V_{B0} and V_{B1} to ensure that both their respective switching elements 304A, 314A are not turned on at the same time.

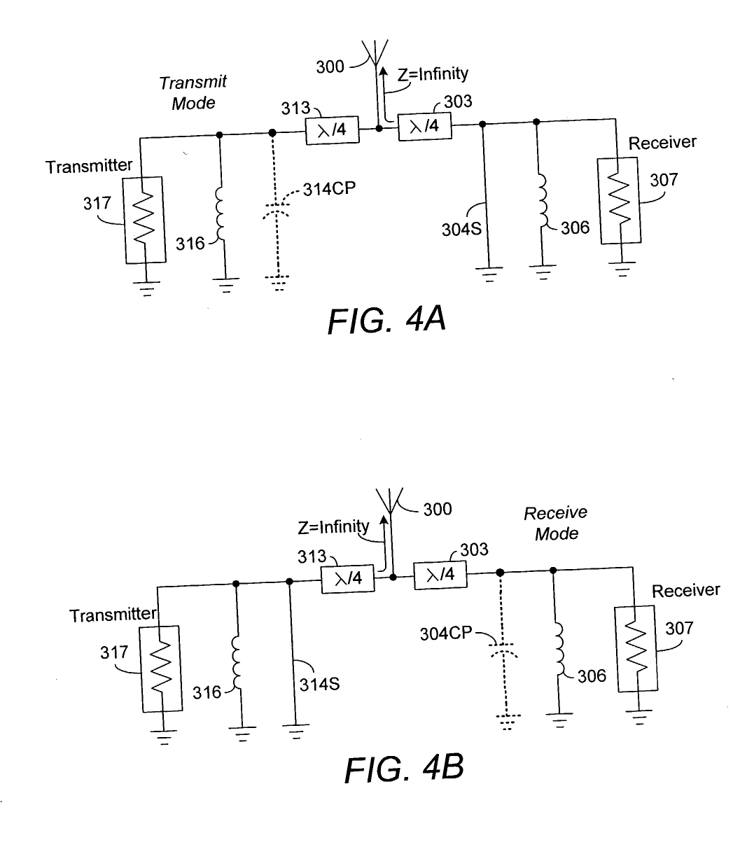

In one embodiment, transmit/receive mode block 390 includes one or more inverting buffers 398, 399 driving switching elements 314A, 304A through resistors 315, 305, respectively. The series-connected inverting buffers ensure that the control voltages V_{B0} and V_{B1} are of opposite polarity at any instant. Thus, as one of the control voltages effectively disables (for example, short-circuits to ground) either the transmitter or receiver connection, the other control voltage turns its corresponding transistor off so as to allow the other of the transmitter or receiver to be connected without interference to the antenna. This operation is described in more detail with reference to the equivalent circuit diagrams of FIGS. 4A and 4B.

A suitable arrangement, such as transmit/receive mode block 390, controls which one of control signals V_{B0} and V_{B1} turns on its corresponding switching element 304A or 314A. This control function may be implemented in any of a variety of ways. For example, an external control signal may simply be fed to first buffer 398. Alternatively, two separate external control signals that themselves constitute control signals V_{B0} and V_{B1} may be fed to the switching elements 304A, 314A through any appropriate buffers and level shifters.

As still another example, the control signals V_{B0} and V_{B1} may be determined dynamically, in accordance with a detected power level of a signal output by the transmitter. For this purpose, a power level detector 380, shown in dotted lines to emphasize its optional nature, is provided. Power level detector 380 determines the power level output by the transmitter toward the antenna 300 and determines whether the power level exceeds a predetermined threshold. The threshold may be chosen to be slightly greater than a power level output by the transmitter when it is not transmitting. The threshold should not be exceeded by levels of expected noise on the path from the transmitter.

When the power threshold is not exceeded (such as during receive mode), the receiver may be connected to the antenna, and the transmitter should be isolated from the antenna so as not to damage the receiver with the transmitter's potentially high power levels. To achieve this purpose, power level detector 380 sends a “receive mode” signal to transmit/receive mode block 390 so that control signal V_{B1} turns on switching element 314A (for example, shorting it to ground). Control signal V_{B0} turns switching element 304A off. Switching element 304A thus does not interfere with the received signal passing through quarter-wave transmission line 303 from antenna 300.

Conversely, when the threshold is exceeded (such as during transmit mode), the transmitter should be connected to the antenna, and the receiver should be isolated from the antenna so as not to be damaged by the transmitter's potentially high power levels. To achieve this purpose, power level detector 380 sends a “transmit mode” signal to transmit/receive mode block 390 so that control signal V_{B0} turns on switching element 304A (for example, shorting it to ground). Control signal V_{B1} turns switching element 314A off. Switching element 314A thus does not interfere with the transmitted signal passing through quarter-wave transmission line 313 to antenna 300.

FIGS. 3B, 3C and 3D illustrate second, third and fourth embodiments of switch circuits. These additional embodiments illustrate that different switching elements, and different ways in which mode signals may drive the switching elements (such as through an RF choke arrangement), may be employed.

Where the structure and operation of the embodiments of FIGS. 3B, 3C, 3D is the same as that of FIG. 3A, the following discussion omits repetitive descriptions. Like elements are labeled with like reference designators, and functionally similar elements are labeled with similar reference designators.

FIG. 3B illustrates a second embodiment of a switch circuit, in which an RF choke arrangement, including inductors 305B and 315B, is used with transmit/receive mode block 390 and transistors 304B, 314B. More specifically, inverting buffers 398, 399 drive the bases of transistors 304B, 314C through inductors 305B, 315B, respectively. In one implementation, the inductors have values of at least about 5 nH. The RF choke presents a very high impedance at the operating frequency, and the equivalent circuit representation during transmit and receive modes (see FIGS. 4A, 4B, discussed below) is essentially unchanged from that of FIG. 3A.

FIG. 3C illustrates a third embodiment of a switch circuit, in which diodes 304C and 314C are used as switching elements instead of the transistors of FIGS. 3A and 3B. Also, an RF choke arrangement, including inductors 305C and 315C and resembling the RF choke arrangement of FIG. 3B, is used. More specifically, inverting buffers 398, 399 drive the diodes 304C, 314C through inductors 305C, 315C, respectively. In one implementation, the inductors have values of at least about 5 nH. The RF choke presents a very high impedance at the operating frequency, and the equivalent circuit representation during transmit and receive modes (see FIGS. 4A, 4B, discussed below) is essentially unchanged from that of FIG. 3A.

FIG. 3D illustrates a fourth embodiment of a switch circuit, in which MOSFETs 304D and 314D are used as switching elements instead of the bipolar transistors of FIGS. 3A and 3B or the diodes of FIG. 3C. More specifically, inverting buffers 398, 399 drive the MOSFETs 304D, 314D through resistors 305D, 315D, respectively. The other elements of FIG. 3D may correspond to those of FIG. 3A, with one implementation adopting values of about 2-10 KΩ for resistors 305D, 315D. With respect to equivalent circuit representations (see FIGS. 4A, 4B, discussed below), the MOSFETs contribute similar functionality and thus the equivalent circuit representation during transmit and receive modes is essentially unchanged from that of FIG. 3A.

Thus, it is seen that the switching elements may be implemented in a variety of technologies, including GaAs (gallium arsenide) heterojunction bipolar transistors (HBTs; see FIGS. 3A, 3B), diodes (see FIG. 3C), and MOSFETs (see FIG. 3D) Thus, the circuit construction may be based on compatibility with the technology of other circuits that are part of a larger system. For example, a power amplifier or a low noise amplifier that may be present in a given RF system may dictate to a large extent the technology that is chosen to implement the switch circuit.

FIG. 4A illustrates an equivalent circuit diagram of FIGS. 3A-3D in “transmit mode,” in which the receiver is isolated from the antenna. Special reference may be made to corresponding elements of FIG. 3A as an example, with the understanding that the equivalent circuits are the same for the alternative embodiments of FIGS. 3B-3D.

In FIG. 4A, transistor 304A (represented as short-circuit element 304S) is turned on by control signal V_{B0} to short-circuit the receiver connection to ground. Inductor 306 and receiver impedance 307 are effectively removed from the circuit, and quarter-wave transmission line 303 presents a substantially infinite impedance as seen from antenna 300. (As used in this specification, “substantially infinite impedance” denotes an impedance presented by a circuit, in which if the circuit were an ideal circuit, the impedance would be theoretically infinite.) In transmit mode, the power that the transmitter sends to the antenna 300 does not reach the receiver, and the receiver does not interfere with the operation of the antenna.

Meanwhile, transistor 314A is turned off by V_{B1}. In its off state, the transistor may be represented by a residual capacitance 314CP. Inductor 316 tunes out capacitance 314CP to prevent interference with the signal that the transmitter sends to antenna 300.

The inductance value of inductor 316 may readily be determined by those skilled in the art. The inductance value of inductor 316 may be determined in accordance with other circuit values such as the capacitance 314CP at the desired RF operating frequency. In one example conducted at 5.5 GHz, an inductance value of 1.6 nH was determined to substantially tune out undesired residual capacitance.

Significantly, the insertion loss experienced along the path between the transmitter and the antenna is low, as it is determined substantially by a non-semiconductor element, in this case quarter-wavelength transmission line 313. Especially at higher frequencies approaching and exceeding about 6 GHz, a quarter wavelength transmission line is small enough as not to occupy excessive area on integrated circuits (ICs), permitting increased integration of the IC.

FIG. 4B illustrates an equivalent circuit diagram in receive mode, in which the transmitter is isolated from the antenna. Special reference may be made to corresponding elements of FIG. 3A as an example, with the understanding that the equivalent circuits are the same for the alternative embodiments of FIGS. 3B-3D.

In FIG. 4B, transistor 314A (represented as short-circuit element 314S) is turned on by control signal V_{B1} to short-circuit the transmitter connection to ground. Inductor 316 and transmitter impedance 317 are effectively removed from the circuit, and quarter-wave transmission line 313 presents an infinite impedance as seen from antenna 300. In receive mode, the transmitter does not interfere with the power that the receiver receives from antenna 300.

Meanwhile, transistor 304A is turned off by V_{B0}. In its off state, the transistor may be represented by a residual capacitance 304CP. Inductor 306 tunes out capacitance 304CP to prevent interference with the signal that is received from antenna 300.

The inductance value of inductor 306 may readily be determined by those skilled in the art. The inductance value of inductor 306 may be determined in accordance with other circuit values such as the capacitance 304CP at the desired RF operating frequency. In one example conducted at 5.5 GHz, an inductance value of 1.6 nH was determined to substantially tune out undesired residual capacitance.

Significantly, the insertion loss experienced along the path between the antenna and the receiver is low, as it is determined substantially by a non-semiconductor element, in this case quarter-wavelength transmission line 303. Especially at higher frequencies approaching and exceeding about 6 GHz, a quarter wavelength transmission line is small enough as not to occupy excessive area on integrated circuits (ICs), permitting increased integration of the IC.

In the foregoing discussions of FIGS. 4A and 4B, it is understood that inductor 305B, inductor 305C and resistor 305D perform the same function of connecting inverting buffer 399 to switching elements 304B, 304C, 304D, in the same manner that resistor 305A connected inverting buffer 399 to transistor 304A. Likewise, it is understood that inductor 315B, inductor 315C and resistor 315D perform the same function of connecting inverting buffer 398 to switching elements 314B, 314C, 314D, in the same manner that resistor 315A connected inverting buffer 398 to transistor 314A. Accordingly, the equivalent circuit diagrams in FIGS. 4A, 4B remain valid for the circuits of FIGS. 3B, 3C and 3D.

From the foregoing, it is apparent that there is provided a switch circuit for selectively connecting either a transmitter or a receiver to an antenna. The switch circuit has a transmitting pathway connecting the transmitter to the antenna (300) and containing only non-semiconductor elements (313), a receiving pathway connecting the antenna to the receiver and containing only non-semiconductor elements (303), and a switching arrangement (314A/B/C/D, 304A/B/C/D) configured to isolate the transmitter from the antenna while enabling the receiving pathway from the antenna to the receiver, and to isolate the receiver from the antenna while enabling the transmitting pathway from the transmitter to the antenna.

The transmitting pathway, the receiving pathway, and the antenna may be configured to carry signals of at least about 6 GHz.

The transmitting pathway may include a first quarter-wave transmission line (313), and the receiving pathway may include a second quarter-wave transmission line (303).

The switching arrangement may include a first switching element (314A/B/C/D) configured to cause the transmitting pathway to present a substantially infinite impedance to the antenna (300) in a receive mode, and a second switching element (304A/B/C/D) configured to cause the receiving pathway to present a substantially infinite impedance to the antenna (300) in a transmit mode.

The first and second switching elements (314A/B/C/D, 304A/B/C/D) may be responsive to at least one mode signal, such that at any instant the first and second switching elements (314A/B/C/D, 304A/B/C/D) cause at least one of the transmitting and receiving pathways to present a substantially infinite impedance to the antenna.

In the transmit mode, the first switching element (314A/B/C/D) may present a first capacitance (314CP), and the switch circuit may further have a first inductor (316) that tunes out the capacitance (314CP).

In the receive mode, the second switching element (304A/B/C/D) may present a second capacitance (304CP), and the switch circuit may further have a second inductor (306) that tunes out the capacitance (304CP).

At least one of the first and second switching elements (314A/B/C/D, 304A/B/C/D) may be a bipolar transistor, a diode, or a MOSFET.

The switch circuit may further have a radio frequency (RF) choke circuit (305B, 315B, 305C, or 315C), connected between a source (390) of a mode signal and at least one of the first and second switching elements (304A/B/C/D, 314A/B/C/D), and may be configured to present a high impedance at an operating frequency of the switch circuit.

Also provided is a switch circuit for selectively connecting either a transmitter or a receiver to an antenna. The switch circuit has a transmitting pathway connecting the transmitter to the antenna (300) and containing a first quarter-wave transmission line (313), a first switching element (314A/B/C/D), connected to the transmitting pathway and configured to cause the transmitting pathway to present a substantially infinite impedance to the antenna (300) in a receive mode, a receiving pathway connecting the antenna to the receiver and containing a second quarter-wave transmission line (303), and a second switching element (304A/B/C/D), connected to the receiving pathway and configured to cause the receiving pathway to present a substantially infinite impedance to the antenna (300) in a transmit mode. The first and second switching elements (314A/B/C/D, 304A/B/C/D) are responsive to at least one mode signal that substantially defines the receive mode and the transmit mode, such that at any instant the first and second switching elements (314A/B/C/D, 304A/B/C/D) cause at least one of the transmitting and receiving pathways to present a substantially infinite impedance to the antenna.

Also provided is a WLAN (wireless local area network) circuit that has an antenna configured to transmit and to receive, a transmitter, a receiver, and the switch circuits described above for selectively connecting either the transmitter or the receiver to an antenna

Many alternatives, modifications, and variations will be apparent to those skilled in the art in light of the above teachings. For example, the choice of elements other than bipolar transistors or diodes or MOSFETs, or elements of different conductivity types, and the choice of different circuit components and configurations, lie within the scope of the present invention. It is therefore to be understood that within the scope of the appended claims and their equivalents, the invention may be practiced otherwise than as specifically described herein.

What is claimed is:

1. A switch circuit for selectively connecting either a transmitter or a receiver to an antenna, the switch circuit comprising:
a transmitting pathway connecting the transmitter to the antenna and containing only non-semiconductor elements;
a receiving pathway connecting the antenna to the receiver and containing only non-semiconductor elements; and
a switching arrangement configured to isolate the transmitter from the antenna while enabling the receiving pathway from the antenna to the receiver, and to isolate the receiver from the antenna while enabling the transmitting pathway from the transmitter to the antenna.

2. The switch circuit of claim 1, wherein:
the transmitting pathway, the receiving pathway, and the antenna are configured to carry signals of at least about 6 GHz.

3. The switch circuit of claim 1, wherein:
the transmitting pathway includes a first quarter-wave transmission line; and
the receiving pathway includes a second quarter-wave transmission line.

4. The switch circuit of claim 3, wherein the switching arrangement includes:
a first switching element configured to cause the transmitting pathway to present a substantially infinite impedance to the antenna in a receive mode; and
a second switching element configured to cause the receiving pathway to present a substantially infinite impedance to the antenna in a transmit mode.

5. The switch circuit of claim 4, wherein:
the first and second switching elements are responsive to at least one mode signal, such that at any instant the first and second switching elements cause at least one of the transmitting and receiving pathways to present a substantially infinite impedance to the antenna.

6. The switch circuit of claim 4, wherein:
in the transmit mode, the first switching element presents a first capacitance; and
the switch circuit further comprises a first inductor that tunes out the capacitance.

7. The switch circuit of claim 4, wherein:
in the receive mode, the second switching element presents a second capacitance; and
the switch circuit further comprises a second inductor that tunes out the capacitance.

8. The switch circuit of claim 4, wherein:
at least one of the first and second switching elements is a bipolar transistor.

9. The switch circuit of claim 4, wherein:
at least one of the first and second switching elements is a diode.

10. The switch circuit of claim 4, wherein:
at least one of the first and second switching elements is a MOSFET.

11. The switch circuit of claim 4, further comprising:
a radio frequency (RF) choke circuit, connected between a source of a mode signal and at least one of the first and second switching elements, and configured to present a high impedance at an operating frequency of the switch circuit.

12. A switch circuit for selectively connecting either a transmitter or a receiver to an antenna, the switch circuit comprising:
a transmitting pathway connecting the transmitter to the antenna and containing a first quarter-wave transmission line;
a first switching element, connected to the transmitting pathway and configured to cause the transmitting pathway to present a substantially infinite impedance to the antenna in a receive mode;
a receiving pathway connecting the antenna to the receiver and containing a second quarter-wave transmission line; and
a second switching element, connected to the receiving pathway and configured to cause the receiving pathway to present a substantially infinite impedance to the antenna in a transmit mode;
wherein the first and second switching elements are responsive to at least one mode signal that substantially defines the receive mode and the transmit mode, such that at any instant the first and second switching elements cause at least one of the transmitting and receiving pathways to present a substantially infinite impedance to the antenna.

13. A WLAN (wireless local area network) circuit, comprising:
a) an antenna configured to transmit and to receive;
b) a transmitter;
c) a receiver; and
d) a switch circuit for selectively connecting either the transmitter or the receiver to an antenna, the switch circuit including:
1) a transmitting pathway connecting the transmitter to the antenna and containing only non-semiconductor elements;
2) a receiving pathway connecting the antenna to the receiver and containing only non-semiconductor elements; and
3) a switching arrangement configured to isolate the transmitter from the antenna while enabling the receiving pathway from the antenna to the receiver, and to isolate the receiver from the antenna while enabling the transmitting pathway from the transmitter to the antenna.

14. The WLAN circuit of claim 13, wherein:
the transmitting pathway includes a first quarter-wave transmission line; and
the receiving pathway includes a second quarter-wave transmission line.

15. The WLAN circuit of claim 14, wherein the switching arrangement includes:
a first switching element configured to cause the transmitting pathway to present a substantially infinite impedance to the antenna in a receive mode; and
a second switching element configured to cause the receiving pathway to present a substantially infinite impedance to the antenna in a transmit mode.

16. The WLAN circuit of claim 15, wherein:
the first and second switching elements are responsive to at least one mode signal, such that at any instant the first and second switching elements cause at least one of the transmitting and receiving pathways to present a substantially infinite impedance to the antenna.

17. The WLAN circuit of claim 15, wherein:
in the transmit mode, the first switching element presents a first capacitance; and
the switch circuit further comprises a first inductor that tunes out the capacitance.

18. The WLAN circuit of claim 15, wherein:
in the receive mode, the second switching element presents a second capacitance; and
the switch circuit further comprises a second inductor that tunes out the capacitance.

19. The WLAN circuit of claim 15, wherein:
at least one of the first and second switching elements is a bipolar transistor.

20. The WLAN circuit of claim 15, wherein:
at least one of the first and second switching elements is a diode.

21. The WLAN circuit of claim 15, wherein:
at least one of the first and second switching elements is a MOSFET.

22. The WLAN circuit of claim 15, further comprising:
a radio frequency (RF) choke circuit, connected between a source of a mode signal and at least one of the first and second switching elements, and configured to present a high impedance at an operating frequency of the switch circuit.
